(19) United States
(12) Patent Application Publication
(10) Pub. No.: US 2025/0166245 A1
(43) Pub. Date: May 22, 2025

(54) AUGMENTING HUMAN VISION USING EXTENDED SPECTRAL DETECTION AND PROCESSING

(71) Applicant: Micron Technology, Inc., Boise, ID (US)

(72) Inventors: Mohad Baboli, Boise, ID (US); John Hopkins, Meridian, ID (US)

(21) Appl. No.: 18/952,510

(22) Filed: Nov. 19, 2024

Related U.S. Application Data
(60) Provisional application No. 63/601,513, filed on Nov. 21, 2023.

(51) Int. Cl. G06T 11/00; H04N 23/13

(52) U.S. Cl. CPC G06T 11/001; H04N 23/13; G06T 2200/24

(57) ABSTRACT

A system and method for providing multispectral vision using a transmitting device or a receiving device with integrated sensors. The transmitting device captures and distributes multispectral information. A receiving device processes non-visible data into enhanced visual representations presented to the user. Alternatively, the receiving device translates non-visible data into neuronal maps transmitted to a linked neuronal interface worn by the user. The interface stimulates the visual cortex with electrical impulses inducing perception of the multispectral information. The flexible architectures enable sensing beyond normal human vision limits by converting non-visible data through visual representation or direct neural stimulation.

### PRIORITY APPLICATION

This application claims the benefit of priority to U.S. Provisional Application Ser. No. 63/601,513, filed Nov. 21, 2023, which is incorporated herein by reference in its entirety.

### TECHNICAL FIELD

The technical field of the invention is providing enhanced multispectral vision by capturing and translating non-visible spectral information into representations perceptible by human sight.

### BACKGROUND

Human sensory perception is confined to a small fraction of the stimuli permeating our environment. Our eyes detect just a thin sliver of electromagnetic radiation known as visible light. Our ears pick up only sound waves within a limited frequency range. Yet our surroundings abound with non-visible signals, unperceived energies, and unheard vibrations. Beyond visible light lie entire spectra of ultraviolet, X-ray, infrared and other wavelengths. Beyond audible sound extends a world of infrasonic rumblings and ultrasonic calls. Evolution has attuned our senses to the tiny slices of reality crucial for survival, while leaving us oblivious to the rest.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram illustrating an example system including a transmitting device equipped with a multispectral sensor and encoder to capture and distribute multispectral information, and a receiving device with a multispectral visual transcriber to process the information for enhanced display, according to some embodiments.

FIG. 2 is a diagram illustrating an example of how different users can perceive information received in at least one non-visible spectral band differently, based on each user's configuration settings for a receiving device, consistent with some examples.

FIG. 3 is a flow diagram illustrating a method for providing multispectral vision via a system such as that illustrated in FIG. 1, consistent with some examples.

FIG. 4 is a diagram illustrating an example of a system including a a receiving device, where the receiving device of the system includes a multispectral sensor for sensing one or more non-visible spectral bands and user interface that enables a user to configure how information received in at least one non-visible spectral band is transmitted to a linked neuronal device, according to some embodiments.

FIG. 5 is a flow diagram illustrating a method for providing multispectral vision via the system illustrated in FIG. 4, consistent with some examples.

FIG. 6 illustrates an example system including a host device and a storage device.

FIG. 7 illustrates a block diagram of an example machine upon which any one or more of the techniques discussed herein may perform.

### DETAILED DESCRIPTION

The present inventors have recognized, among other things, that the human eye can only detect a small portion of the electromagnetic spectrum, missing out on non-visible forms of light like ultraviolet, infrared, and X-rays, and that developing technologies offer the possibility of overcoming these limitations. Recent advances in sensors, neuroscience, and computer vision have paved the way for electronic and software-based systems that can capture spectral information beyond visible light and convert it into representations compatible with the human nervous system. This non-visible light may be presented to the user in different ways.

Some embodiments of the present invention involve a system for providing enhanced multispectral vision using a transmitting device and a receiving device. The transmitting device includes one or more sensors capable of capturing information across multiple spectral bands, including both visible light in the 400-700 nm wavelength range detectable by the human eye, as well as non-visible wavelengths such as infrared, ultraviolet, X-rays, and microwaves. The transmitting device contains one or more encoders to translate the raw multispectral data into encoded signals suitable for wireless transmission. The encoded multispectral information is then broadcast wirelessly over a defined area.

The receiving device includes sensors designed to detect the transmitted multispectral signals broadcast by the transmitting device. The receiving device has processing capabilities to decode the received multispectral information back into the original raw data form. This data is passed to a multispectral visual transcriber which analyzes the non-visible spectral components and converts them into visual representations compatible with human vision. The transcribing of the non-visible spectral components is done in accordance with one or more user-provided configuration settings, established by a user manipulating a user interface of the receiving device.

For example, based on the user configuration settings, infrared wavelengths may be shifted into hues in the red/green visible spectrum. Ultraviolet light could be shifted into blue/purple hues. The multispectral visual transcriber leverages user configuration settings to allow customization of how non-visible data gets translated into enhanced visual data. The settings control properties like color, brightness, and contrast.

Finally, the enhanced multispectral visual data consisting of both the original visible light and the translated non-visible data is passed to a display, for presentation to the user. The display presents the enhanced imagery to the user. For example, the display could be part of an augmented reality headset worn by the user, overlaying the enhanced spectral information on their natural vision. This provides the user an augmented view of the world with additional spectral details beyond normal human perception.

Consistent with some embodiments, the receiving device in the system does not have to be an augmented reality headset, but instead may be a mobile computing device such as a smartphone or tablet. In this case, the smartphone would include sensors capable of detecting the multispectral signals transmitted by the broadcasting device. The smartphone processors would decode the received multispectral data. The visual transcriber module running on the smartphone would then convert the non-visible spectral components into visual representations, again based on user configuration settings.

The smartphone image sensor would capture regular visible light video and images. This visible light imagery is then combined and integrated with the processed non-visible data. The combined multispectral visual information would then be displayed to the user on the smartphone display. Accordingly, the user will see the standard visible light camera view augmented with additional spectral details layered over it, providing enhanced vision beyond normal human perception limits.

In some alternative embodiments of the present invention, a system includes a receiving device, which itself contains multispectral sensors to capture comprehensive spectral information across both visible and non-visible wavelengths. This receiving device includes sensors optimized for multispectral imaging, such as specialized CMOS or CCD image sensors with sensitivity extending into infrared, ultraviolet, and potentially X-ray bands. The raw multispectral data is processed by a multispectral neural transcriber module. This neural transcriber module analyzes the non-visible components of the captured video signal. It then converts the non-visible data into neuronal maps-representations optimized for transmission to and interpretation by the human visual cortex.

The neuronal maps encode the captured multispectral information in a format suited for inducing visual perception through direct neural stimulation. The neuronal maps are transmitted to a linked neuronal device worn by the user. The link between the receiving device and neuronal device may utilize wireless technology like WiFi or Bluetooth. The neuronal device receives the transmitted neuronal maps via this link. The neuronal device receives the transmitted neuronal maps via this link. In one implementation, the neuronal device includes magnetic non-invasive electrodes placed against the user's head to deliver electrical impulses to the visual cortex region of the brain. In another implementation, the neuronal device is an implanted brain computer interface with electrodes surgically embedded within the brain. The electrodes, whether non-invasive external units or implanted internal units, stimulate relevant neuronal pathways to induce sensory patterns matching the encoded multispectral data. This enables the user to perceive the full range of both visible and non-visible spectral information as enhanced visual images overlaid on their natural vision. The user gains augmented sight exceeding normal human visual acuity constraints regardless of whether non-invasive or implanted electrodes are used for neural stimulation.

Consistent with some embodiments of the present invention, the receiving device that captures the multispectral information can take various forms, including a head-mounted augmented reality device, a handheld mobile device such as a smartphone, or a stationary sensor device. If the receiving device is an AR headset, the AR device includes multispectral sensors such as specialized CMOS or CCD image sensors capable of detecting light across visible, infrared, ultraviolet, and potentially X-ray or microwave spectrums. The AR headset contains integrated processors to encode the captured multispectral data into neuronal maps optimized for visual cortex stimulation.

In the case of a mobile device implementation, the smartphone or tablet is equipped with multispectral cameras and sensors to capture comprehensive wavelength information. Internal processors encode this data into neuronal map representations.

For a stationary receiving device configuration, multispectral cameras and sensors would be set up in fixed locations to capture spectral data across broad surroundings. This data would be wirelessly transmitted to a linked processing unit which encodes the data into neuronal maps.

Regardless of the form of the receiving device-AR, mobile, or stationary—the captured multispectral data is encoded into neuronal maps and transmitted to a linked neuronal interface worn by the user. This neuronal device stimulates the user's visual cortex with electrical impulses corresponding to the neuronal maps, inducing augmented multispectral vision. The flexible receiving device implementations enable enhanced spectral sight in diverse scenarios. Other advantages and aspects of the present invention are described below in connection with the description of the several figures that follows.

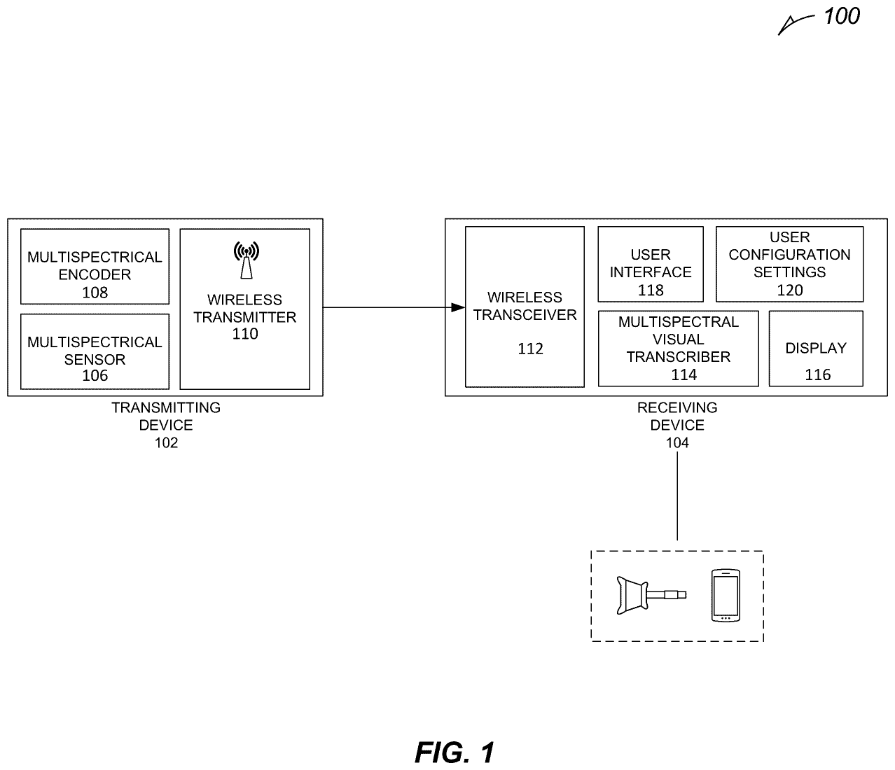

FIG. 1 illustrates an example system 100 for providing enhanced multispectral vision using a transmitting device 102 and a receiving device 104. The transmitting device 102 includes a multispectral sensor 106 capable of capturing electromagnetic radiation across a broad range of wavelengths, both within and outside the visible light spectrum detectable by the human eye.

The multispectral sensor 106 may utilize advanced CMOS or CCD image sensor technologies optimized for multispectral imaging, with sensitivity extending into infrared, ultraviolet, X-ray, microwave, and other bands. This enables comprehensive capture of spectral information across the environment.

The captured multispectral data is passed to a multispectral encoder 108. This encoder 108 translates the raw sensor data into encoded signals suitable for wireless transmission. Various encoding schemes may be utilized, such as modulation or multiplexing of the spectral bands into a composite signal.

The encoded multispectral information is then transmitted wirelessly over a defined area by the wireless transmitter 110. The transmitter 110 may use standard wireless protocols like Wi-Fi, Bluetooth, Zigbee, or custom high-bandwidth radio transmission technologies. The wireless transmission range, directionality, and connectivity profiles can be tailored as needed for different applications.

The receiving device 104 includes a wireless transceiver 112 or similar component, including sensors and/or receivers capable of detecting the transmitted multispectral signals from the transmitting device 102. For example, a matching multispectral antenna and demodulator may be used to receive and decode the signal.

The received data is passed to a multispectral visual transcriber module 114. This transcriber 114 analyzes the non-visible spectral components, such as infrared or ultraviolet wavelengths, and converts them into visual representations compatible with human vision. For instance, algorithms may process the data to shift non-visible wavelengths into visible colors, intensities, and patterns.

Translation of the non-visible bands into enhanced visual data is performed according to one or more user configuration settings 120 accessed via the user interface 118 of the receiving device. These settings allow customization of how spectral components are rendered for the user 104.

Finally, the enhanced multispectral visual data, including both original visible light and translated non-visible data, is passed to the display 116 and presented to the user. The display 116 overlays the enhanced spectral information on the user's natural vision, augmenting their view of the world with added spectral details exceeding normal human perception limits.

The user configuration settings 120 accessed via the receiving device 104 user interface 118 allow each user to customize how the multispectral visual transcriber 114 processes and renders the non-visible spectral data. For example, the settings may specify particular algorithms to shift certain infrared wavelengths into corresponding red hues or map ultraviolet intensities to blue shades.

More advanced configuration options allow for control parameters like brightness, contrast, color gradients, flickering patterns, and other properties applied during translation of non-visible bands into enhanced visual representations. Users may select from preset rendering modes or create highly customized mapping profiles tailored to their personal preferences.

The configuration settings 120 also enable flexibility in how the translated multispectral imagery is presented on the display. One option overlays the enhanced spectral data on top of the visible light video imagery, providing an augmented reality view. However, users could also choose to show only the translated non-visible data without the underlying visible video. For instance, infrared wavelengths could be rendered as a heat map gradient isolated from the visible scene. Or ultraviolet data could be displayed independently as a waveform plot. This allows users to view specific spectral translations more clearly for analysis. The system's configurable settings empower each user to define both how non-visible wavelengths get translated as well as how the enhanced imagery ultimately appears.

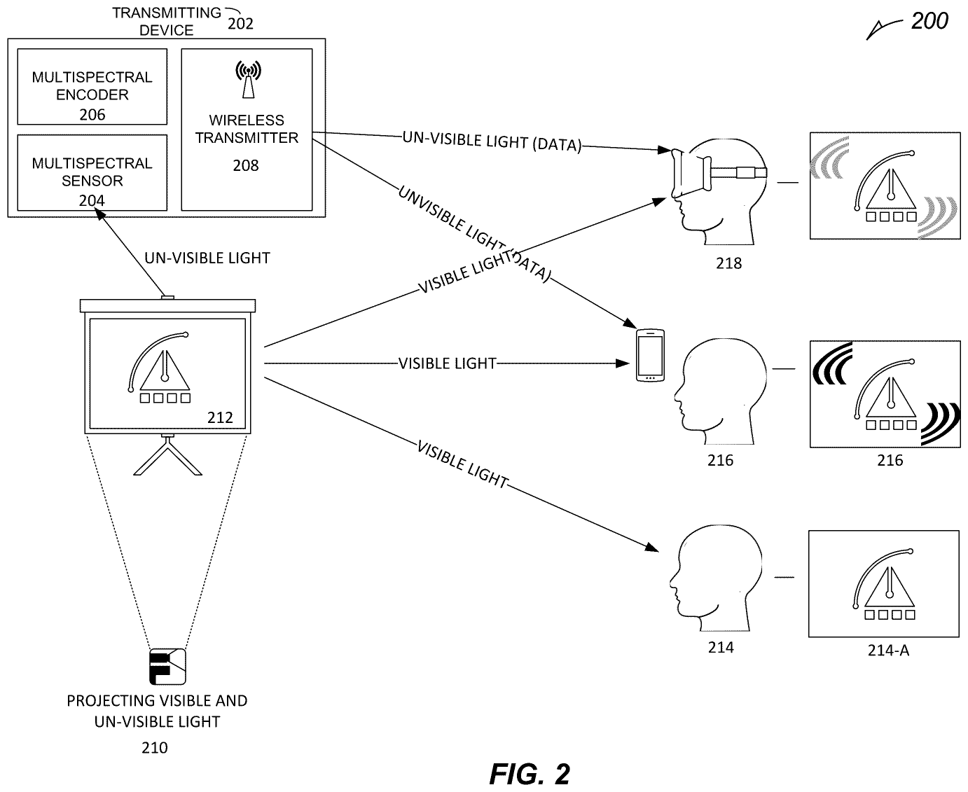

FIG. 2 illustrates an example scenario where a transmitting device 202 equipped with a multispectral sensor 204 captures both visible and non-visible light projected onto a screen 212. The transmitting device 202 uses an encoder 206 to encode the raw multispectral data and wirelessly broadcast the encoded information over the surrounding area, via the wireless transmitter 208.

In this example, a projector 210 casts combined visible and non-visible light onto the screen 212. To a user 214 directly viewing the projection, only the visible component is perceptible, as shown with reference 214-A. However, users 208 and 218 with receiving devices can detect the non-visible elements via the wireless broadcast from the transmitting device 209.

For example, the person operating the mobile device 216 and the person wearing the AR headset 218 have devices that include wireless receivers to detect the transmitted multispectral data, such as Wi-Fi or custom protocols tuned to the broadcast. Internal processors decode the received multispectral information back into the original raw sensor data form.

The multispectral visual transcriber module in each receiving device then converts the non-visible elements, such as infrared or ultraviolet wavelengths, into enhanced visual representations tailored to each user's individual configuration settings. For instance, the user 216 with the mobile device may choose to see infrared frequencies as red overlays 216-A, while the user 218 wearing the AR device may specify a configuration setting that indicates infrared is to appear as blue highlights. The transcriber modules in the receiving devices translate the same non-visible data differently for each user.

Finally, the enhanced multispectral imagery is shown on the display of each receiving device. This augments the normal visible scene with additional spectral details based on the non-visible elements detected wirelessly from the transmitting device 202. Accordingly, FIG. 2 demonstrates how the system allows multiple receiving devices to obtain enhanced multispectral vision from a central transmitting device's broadcast. Each user can customize how non-visible data gets translated into augmented visual representations according to their preferences.

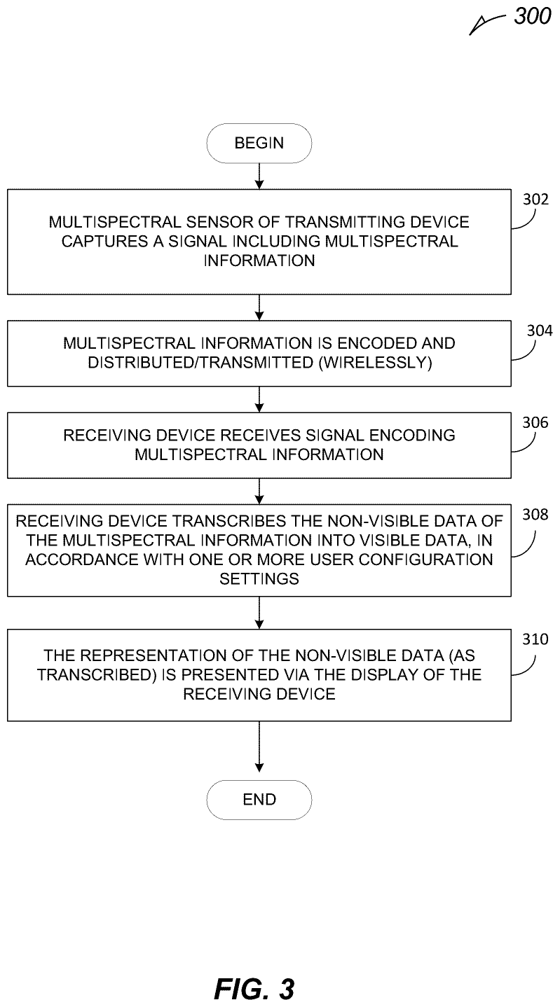

FIG. 3 shows a flowchart outlining the method operations involved in a method 300 performed by the system of FIG. 1 to provide enhanced multispectral vision to a user. First, a multispectral sensor of a transmitting or broadcasting device captures a video signal containing multispectral information across both visible and non-visible spectral bands 302. The non-visible bands may include infrared, ultraviolet, X-rays, microwaves, or other wavelengths outside normal human perception.

The captured multispectral video signal is then distributed over a specific area by the transmitting device 304. This distribution may involve wireless transmission protocols and encoding to optimize broadcast of the data. A receiving device with a compatible sensor detects the distributed multispectral information 306. The received data is passed to a multispectral visual transcriber module within the receiving device. Here the video signal is transcribed into visual data 308, according to one or more configuration parameters or settings, provided by a user of the receiving device. For instance, infrared frequencies could be shifted into red hues based on the settings.

Finally, the enhanced multispectral visual data is rendered on the display 308. The rendering of the data is generally done in accordance with one or more configuration settings. In some instances, the rendering of the representation of the non-visible data may consisting of both the original visible light and translated non-visible data, as displayed to the user. This provides an augmented reality view overlaying additional spectral details beyond normal human perception limits onto the natural scene. However, in other instances, only the visible representation of the translated non-visible data may be rendered. The flexible system architecture and configuration settings enable each user to obtain a customized multispectral vision enhancement experience tailored to their preferences.

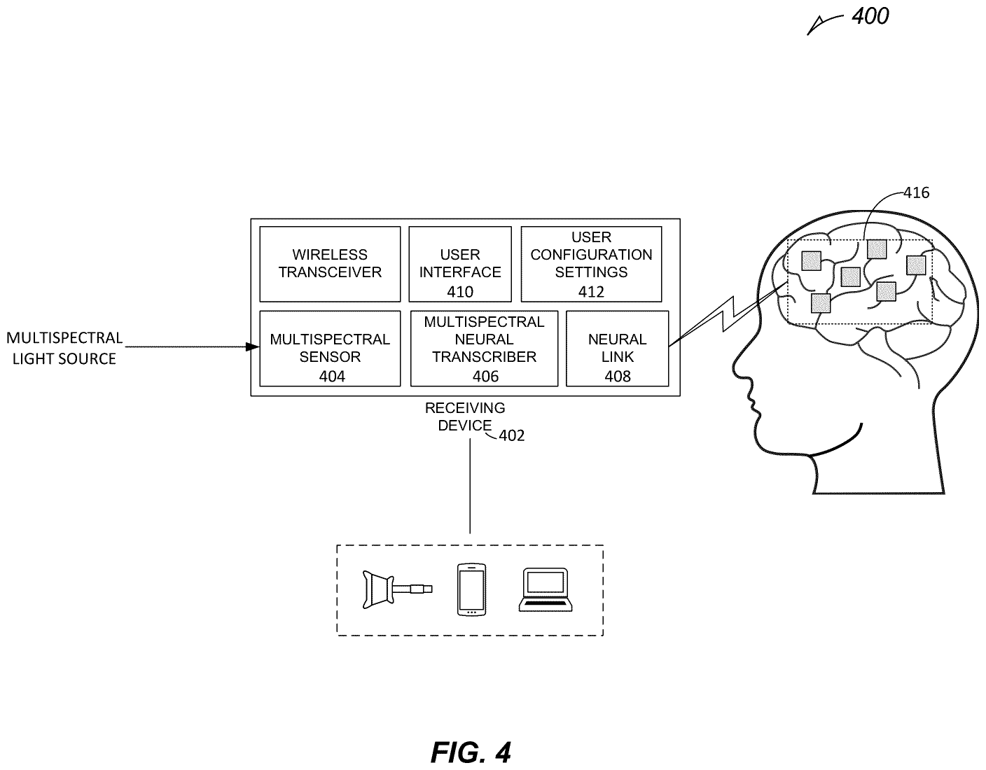

FIG. 4 illustrates an example system 400 including a receiving device 402 for providing enhanced multispectral vision. In this system 403, the receiving device 402 itself contains one or more multispectral sensors 404 to capture comprehensive spectral information across both visible and non-visible wavelengths. The receiving device includes a multispectral sensor 400 capable of detecting light across visible, infrared, ultraviolet, and potentially X-ray or microwave spectrums. This enables the sensor 404 to capture video signals containing multispectral data.

The captured multispectral video signal is passed to a multispectral neural transcriber 406 within the receiving device 402. This neural transcriber 406 analyzes the non-visible components of the video signal and converts them into neuronal maps.

The neuronal maps encode the multispectral information in a format optimized for transmission to and interpretation by the human visual cortex. The neuronal maps represent the captured visible and non-visible data in a way that can induce visual perception through neural stimulation. The neuronal maps are transmitted, via a neuronal link 408 from the receiving device 402 to a linked neuronal device 416 of the user. This transmission occurs via a wired or wireless link, such as Bluetooth or Wi-Fi, to provide robust connectivity.

In one implementation, the neuronal device 416 contains multiple electrodes arranged in an array positioned non-invasively against the user's scalp. The electrode array targets the visual cortex region to deliver localized electrical stimulation to sensory neurons based on the neuronal map instructions. In another implementation, the neuronal device 416 is an implanted brain computer interface with electrodes surgically embedded within the brain. The implanted electrodes stimulate relevant neuronal pathways directly within the visual cortex to induce sensory patterns matching the multispectral data.

In addition to external and implanted electrodes, emerging technologies like focused ultrasound could be leveraged. Focused ultrasound transducers could non-invasively transmit targeted acoustic pulses into the brain to activate sensory neurons. Nanoparticle assemblies could also potentially be delivered to neurons of interest. Applied electromagnetic fields could then stimulate the nanoparticles, inducing local neuron activation aligned with the multispectral data patterns. Regardless of the stimulation mechanism—external electrodes, implanted electrodes, focused ultrasound, nanoparticles, etc.—the neuronal device converts the neuronal maps into electrical, acoustic, or electromagnetic signals tuned to safely elicit sensory neuron firing. This stimulates the visual cortex to perceive the enhanced multispectral imagery.

The receiving device 402 contains a user interface 410 that allows each user to define custom settings 412 to control how multispectral data gets processed into neuronal maps. The interface 410 may include options like dropdown menus, sliders, and text fields to tune parameters. For example, the user could select specific algorithms to determine how infrared wavelengths get translated into corresponding colors in the visible spectrum. One algorithm may map longer infrared wavelengths to red hues, while another maps them to purple. The user may also adjust weighting factors to set the intensity and saturation of the colors representing non-visible bands. Increased weighting results in brighter, more vibrant colors for those spectral components. Advanced settings 412 allow customization of the neural encoding process used to generate the neuronal maps. Users may specify the types of neuron stimulation patterns used to represent textures, edges, motion, and other visual features. The interface 410 may even give users direct control over stimulation parameters like electrode pulse frequency and amplitude. This enables tuning the neuronal experience for maximum clarity and comfort. Preset modes can be provided, allowing users to select optimized neuronal mapping configurations for different applications. The system allows both high-level and low-level customization of how multispectral data gets processed and delivered to the user's visual cortex.

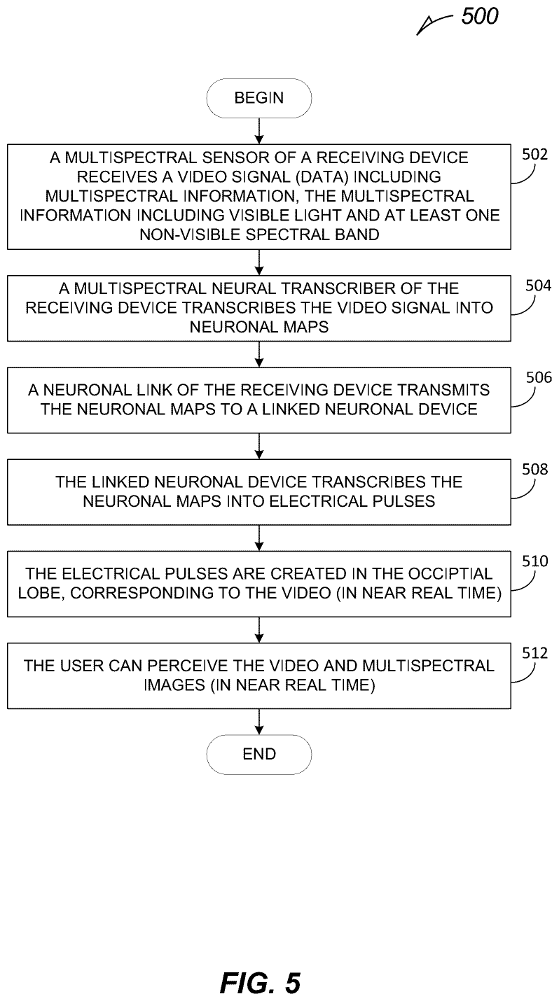

FIG. 5 depicts a flowchart illustrating the method operations involved in a method performed by the system shown in FIG. 4 to provide enhanced multispectral vision to a user. First, the multispectral sensor of the receiving device captures a video signal 502 containing multispectral information across both visible and non-visible spectral bands. This sensor could employ CMOS or CCD technologies optimized for detecting wavelengths ranging from visible light through infrared and potentially ultraviolet.

The captured multispectral video signal is passed to the multispectral neural transcriber 504. Here the video signal is transcribed into neuronal maps that encode the multispectral data, including translation of non-visible wavelengths into representations compatible with visual cortex stimulation. Various neural encoding schemes could be utilized to optimize the maps for transmission and interpretation.

The neuronal maps are then transmitted 506 from the receiving device to the linked neuronal device using a wired or wireless transmission link—e.g., a neuronal link. The link technology should provide robust high-bandwidth connectivity to enable real-time transmission of the neuronal maps.

The linked neuronal device receives the neuronal maps 508 via the transmission link and converts them into electrical impulses using an array of non-invasive magnetic electrodes placed against the user's head. The electrodes could be arranged over visual cortex areas to stimulate relevant neuronal pathways. The electrical impulses correspond to the neuronal map data and may involve patterns of current pulses optimized for sensory neuron activation. These electrical impulses are delivered to the user's occipital lobe 510, targeting the visual cortex specifically. This induces sensory neuronal activation that the brain interprets as visual information.

The result is that the user experiences the multispectral video input, including both original visible light data and translated non-visible data, as enhanced visual images overlaid on their natural vision. This provides an augmented reality view with additional spectral details.

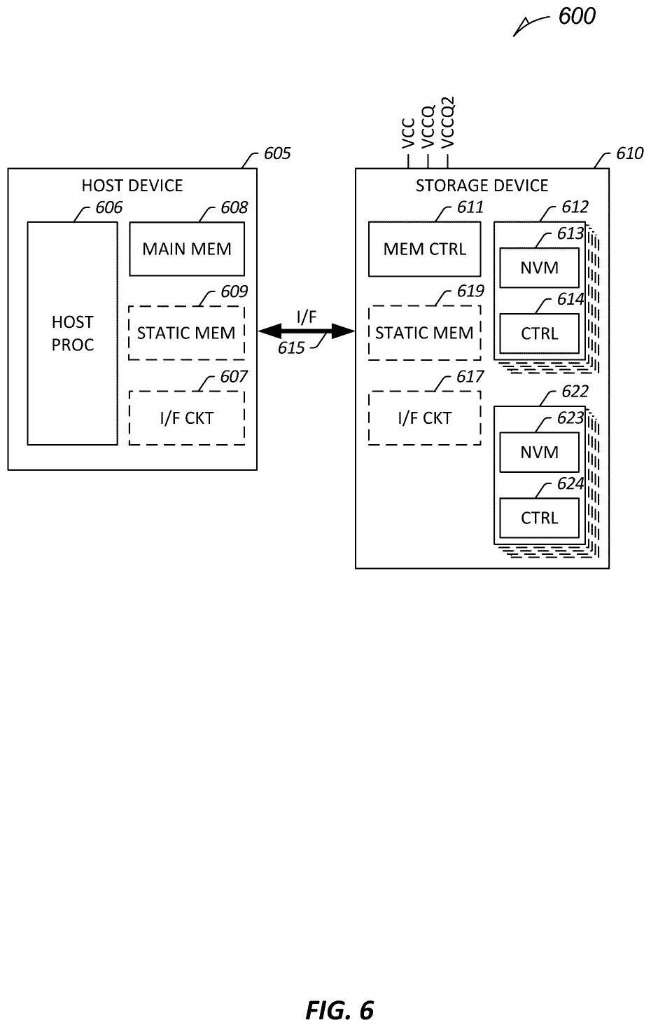

FIG. 6 illustrates an example system 600 (e.g., a host system or processor system) including a host device 605 and a storage device 610 configured to communicate over a communication interface (I/F) 615 (e.g., a bidirectional parallel or serial communication interface). In an example, the communication interface 615 can be referred to as a host interface. The host device 605 can include a host processor 606 (e.g., a host central processing unit (CPU) or other processor or processing circuitry, such as a memory management unit (MMU), interface circuitry, etc.). In certain examples, the host device 605 can include a main memory (MAIN MEM) 608 (e.g., DRAM, etc.) and optionally, a static memory (STATIC MEM) 609, to support operation of the host processor (HOST PROC) 606.

The storage device 610 can include a non-volatile memory device, in certain examples, a single device separate from the host device 605 and components of the host device 605 (e.g., including components illustrated in FIG. 6), in other examples, a component of the host device 605, and in yet other examples, a combination of separate discrete components. For example, the communication interface 615 can include a serial or parallel bidirectional interface, such as defined in one or more Joint Electron Device Engineering Council (JEDEC) standards.

The storage device 610 can include a memory controller (MEM CTRL) 611 and a first non-volatile memory device 612. The memory controller 611 can optionally include a limited amount of static memory 619 (or main memory) to support operations of the memory controller 611. In an example, the first non-volatile memory device 612 can include a number of non-volatile memory devices (e.g., dies or LUNs), such as one or more stacked flash memory devices (e.g., as illustrated with the stacked dashes underneath the first non-volatile memory device 612), etc., each including non-volatile memory (NVM) 613 (e.g., one or more groups of non-volatile memory cells) and a device controller (CTRL) 614 or other periphery circuitry thereon (e.g., device logic, etc.), and controlled by the memory controller 611 over an internal storage-system communication interface (e.g., an Open NAND Flash Interface (ONFI) bus, etc.) separate from the communication interface 615. Control circuitry, as used herein, can refer to one or more of the memory controller 611, the device controller 614, or other periphery circuitry in the storage device 610, the NVM device 612, etc.

Flash memory devices typically include one or more groups of one-transistor, floating gate (FG) or replacement gate (RG) (or charge trapping) storage structures (memory cells). The memory cells of the memory array are typically arranged in a matrix. The gates of each memory cell in a row of the array are coupled to an access line (e.g., a word line). In NOR architecture, the drains of each memory cell in a column of the array are coupled to a data line (e.g., a bit line). In NAND architecture, the drains of each memory cell in a column of the array are coupled together in series, source to drain, between a source line and a bit line.

Each memory cell in a NOR, NAND, 3D XPoint, FeRAM, MRAM, or one or more other architecture semiconductor memory array can be programmed individually or collectively to one or a number of programmed states. A single-level cell (SLC) can represent one bit of data per cell in one of two programmed states (e.g., 1 or 0). A multi-level cell (MLC) can represent two or more bits of data per cell in a number of programmed states (e.g., 2n, where n is the number of bits of data). In certain examples, MLC can refer to a memory cell that can store two bits of data in one of 4 programmed states. A triple-level cell (TLC) can represent three bits of data per cell in one of 8 programmed states. A quad-level cell (QLC) can represent four bits of data per cell in one of 16 programmed states. In other examples, MLC can refer to any memory cell that can store more than one bit of data per cell, including TLC and QLC, etc.

In three-dimensional (3D) architecture semiconductor memory device technology, memory cells can be stacked, increasing the number of tiers, physical pages, and accordingly, the density of memory cells in a memory device. Data is often stored arbitrarily on the storage system as small units. Even if accessed as a single unit, data can be received in small, random 4-16 k single file reads (e.g., 60%-80% of operations are smaller than 16 k). It is difficult for a user and even kernel applications to indicate that data should be stored as one sequential cohesive unit. File systems are typically designed to optimize space usage, and not sequential retrieval space.

The memory controller 611, separate from the host processor 606 and the host device 605, can receive instructions from the host device 605, and can communicate with the first non-volatile memory device 612, such as to transfer data to (e.g., write or erase) or from (e.g., read) one or more of the memory cells of the first non-volatile memory device 612. The memory controller 611 can include, among other things, circuitry or firmware, such as a number of components or integrated circuits. For example, the memory controller 611 can include one or more memory control units, circuits, or components configured to control access across the memory array and to provide a translation layer between the host device 605 and the storage system 600, such as a memory manager, one or more memory management tables, etc.

In an example, the storage device 610 can include a second non-volatile memory device 622, separate from the first non-volatile memory device 612, the second non-volatile memory device 622 can include a number of non-volatile memory devices, etc., each including non-volatile memory 623 and a device controller 624 or other periphery circuitry thereon, and controlled by the memory controller 611 over an internal storage-system communication interface separate from the communication interface 615. In an example, the first non-volatile memory device 612 can be configured as a “cold tier” memory device and the second non-volatile memory device 622 can be configured as a “warm tier” memory device (while the main memory 608, the static memory 609, the static memory 619 (or main memory) can be configured as a “hot tier” memory).

The memory manager can include, among other things, circuitry or firmware, such as a number of components or integrated circuits associated with various memory management functions, including, among other functions, wear leveling (e.g., garbage collection or reclamation), error detection or correction, block retirement, or one or more other memory management functions. The memory manager can parse or format host commands (e.g., commands received from the host device 605) into device commands (e.g., commands associated with operation of a memory array, etc.), or generate device commands (e.g., to accomplish various memory management functions) for the device controller 614 or one or more other components of the storage device 610.

The memory manager can include a set of management tables configured to maintain various information associated with one or more component of the storage device 610 (e.g., various information associated with a memory array or one or more memory cells coupled to the memory controller 611). For example, the management tables can include information regarding block age, block erase count, error history, or one or more error counts (e.g., a write operation error count, a read bit error count, a read operation error count, an erase error count, etc.) for one or more blocks of memory cells coupled to the memory controller 611. In certain examples, if the number of detected errors for one or more of the error counts is above a threshold, the bit error can be referred to as an uncorrectable bit error. The management tables can maintain a count of correctable or uncorrectable bit errors, among other things. In an example, the management tables can include translation tables or a L2P mapping.

The memory manager can implement and use data structures to reduce storage device 610 latency in operations that involve searching L2P tables for valid pages, such as garbage collection. To this end, the memory manager is arranged to maintain a data structure (e.g., table region data structure, tracking data structure, etc.) for a physical block. The data structure includes indications of L2P mapping table regions, of the L2P table. In certain examples, the data structure is a bitmap (e.g., a binary array). In an example, the bitmap includes a bit for each region of multiple, mutually exclusive, regions that span the L2P table.

The first non-volatile memory device 612 or the non-volatile memory 613 (e.g., one or more 3D NAND architecture semiconductor memory arrays) can include a number of memory cells arranged in, for example, a number of devices, planes, blocks, physical pages, super blocks, or super pages. As one example, a TLC memory device can include 18,592 bytes (B) of data per page, 1536 pages per block, 548 blocks per plane, and 4 planes per device. As another example, an MLC memory device can include 18,592 bytes (B) of data per page, 1024 pages per block, 548 blocks per plane, and 4 planes per device, but with half the required write time and twice the program/erase (P/E) cycles as a corresponding TLC memory device. Other examples can include other numbers or arrangements. A super block can include a combination of multiple blocks, such as from different planes, etc., and a window can refer to a stripe of a super block, typically matching a portion covered by a physical-to-logical (P2L) table chunk, etc., and a super page can include a combination of multiple pages.

The term “super” can refer to a combination or multiples of a thing or things. For examples, a super block can include a combination of blocks. If a memory device includes 4 planes, a super block may refer to the same block on each plane, or a pattern of blocks across the panes (e.g., a combination of block 0 on plane 0, block 1 on plane 1, block 2 on plane 2, and block 3 on plane 3, etc.). In an example, if a storage system includes multiple memory devices, the combination or pattern of blocks can extend across the multiple memory devices. The term “stripe” can refer to a pattern of combination or pattern of a piece or pieces of a thing or things. For example, a stripe of a super block can refer to a combination or pattern of pages from each block in the super block.

In operation, data is typically written to or read from the storage device 610 in pages and erased in blocks. However, one or more memory operations (e.g., read, write, erase, etc.) can be performed on larger or smaller groups of memory cells, as desired. For example, a partial update of tagged data from an offload unit can be collected during data migration or garbage collection to ensure it was re-written efficiently. The data transfer size of a memory device is typically referred to as a page, whereas the data transfer size of a host device is typically referred to as a sector. Although a page of data can include a number of bytes of user data (e.g., a data payload including a number of sectors of data) and its corresponding metadata, the size of the page often refers only to the number of bytes used to store the user data. As an example, a page of data having a page size of 4 kB may include 4 kB of user data (e.g., 8 sectors assuming a sector size of 512B) as well as a number of bytes (e.g., 32B, 54B, 224B, etc.) of auxiliary or metadata corresponding to the user data, such as integrity data (e.g., error detecting or correcting code data), address data (e.g., logical address data, etc.), or other metadata associated with the user data.

Different types of memory cells or memory arrays can provide for different page sizes or may require different amounts of metadata associated therewith. For example, different memory device types may have different bit error rates, which can lead to different amounts of metadata necessary to ensure integrity of the page of data (e.g., a memory device with a higher bit error rate may require more bytes of error correction code (ECC) data than a memory device with a lower bit error rate). As an example, an MLC NAND flash device may have a higher bit error rate than a corresponding SLC NAND flash device. As such, the MLC device may require more metadata bytes for error data than the corresponding SLC device.

In an example, the data in a chunk or data unit can be managed in an optimized manner throughout its tenure on the storage system. For example, the data is managed as one unit during data migration (e.g., garbage collection, etc.) such that the efficient read/write properties are preserved as data is moved to its new physical location on the storage system. In certain examples, the only limit to the number of chunks, data units, or blocks configurable for storage, tagging, etc., are the capacities of the system.

One or more of the host device 605 or the storage device 610 can include interface circuitry, such as a host interface circuit (I/F CKT) 707 or a storage interface circuit (I/F CKT) 617, configured to enable communication between components of the host system 600. Each interface circuit can include one or more interconnect layers, such as mobile industry processor interface (MIPI) Unified Protocol (UniPro) and M-PHY layers (e.g., physical layers), including circuit components and interfaces. The M-PHY layer includes the differential transmit (TX) and receive (RX) signaling pairs (e.g., DIN_t, DIN_c and DOUT_t, DOUT_c, etc.). In certain examples, the host interface circuit 707 can include a controller (e.g., a UFS controller), a driver circuit (e.g., a UFS driver), etc. Although described herein with respect to the UniPro and M-PHY layers, one or more other set of circuit components or interfaces can be used to transfer data between circuit components of the host system 600.

Components of the host system 600 can be configured to receive or operate using one or more host voltages, including, for example, VCC, VCCQ, and, optionally, VCCQ2. In certain examples, one or more of the host voltages, or power rails, can be managed or controlled by a power management integrated circuit (PMIC). In certain examples, VCC can be a first supply voltage (e.g., 2.7V-3.3V, 1.7V-1.95V, etc.). In an example, one or more of the static memory 619 or the non-volatile memory devices 612 can require VCC for operation. VCCQ can be a second supply voltage, lower than the VCC (e.g., 1.1V-1.3V, etc.). In an example, one or more of the memory controller 611, the communication interface 615, or memory I/O or other low voltage blocks can optionally require VCCQ for operation. VCCQ2 can be a third supply voltage between VCC and VCCQ (e.g., 1.7V-1.95V, etc.). In an example, one or more of the memory controller 611 of the communication interface, or other low voltage block can optionally require VCCQ2. Each host voltage can be set to provide voltage at one or more current levels, in certain examples, controllable by one or more device descriptors and levels (e.g., between [0:15], each representing a different maximum expected source current, etc.).

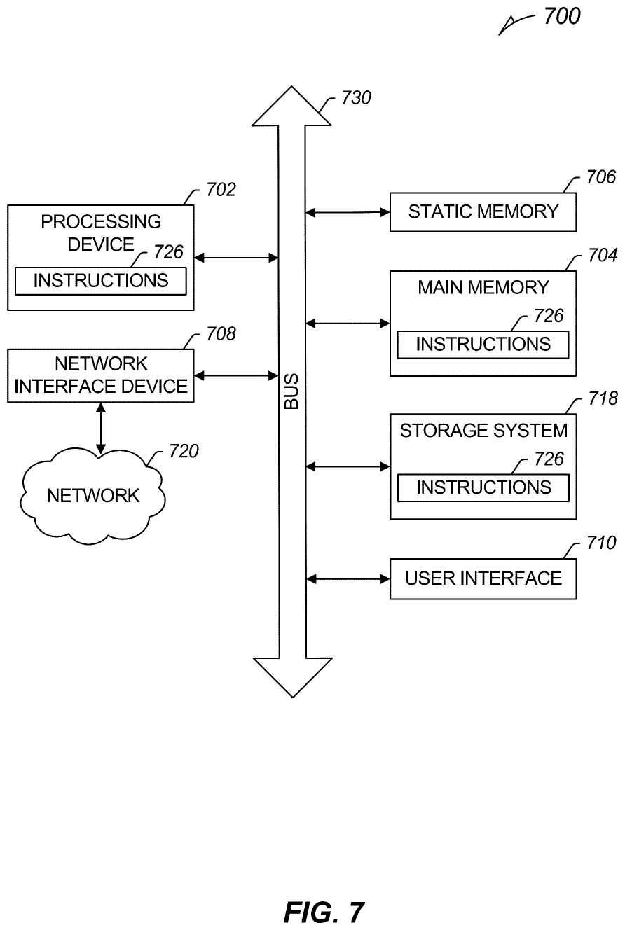

FIG. 7 illustrates a block diagram of an example machine 700 (e.g., a host system) upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may function as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 700 (e.g., computer system, a host system, etc.) may include a processing device 702 (e.g., a hardware processor, a central processing unit (CPU), a graphics processing unit (GPU), a hardware processor core, or any combination thereof, etc.), a main memory 704 (e.g., read-only memory (ROM), dynamic random-access memory (DRAM), a static memory 706 (e.g., static random-access memory (SRAM), etc.), and a storage system 818, some or all of which may communicate with each other via a communication interface 830 (e.g., a bus).

The processing device 702 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 can be configured to execute instructions 726 for performing the operations and steps discussed herein. The machine 700 can further include a network interface device 708 to communicate over a network 720.

The storage system 718 can include a machine-readable storage medium (also known as a computer-readable medium) on which is stored one or more sets of instructions 726 or software embodying any one or more of the methodologies or functions described herein. The instructions 726 can also reside, completely or at least partially, within the main memory 704 or within the processing device 702 during execution thereof by the machine 700, the main memory 704 and the processing device 702 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 700 may further include a user interface 710, such as one or more of a display unit, an alphanumeric input device (e.g., a keyboard), and a user interface (UI) navigation device (e.g., a mouse), etc. In an example, one or more of the display unit, the input device, or the UI navigation device may be a touch screen display. The machine a signal generation device (e.g., a speaker), or one or more sensors, such as a global positioning system (GPS) sensor, compass, accelerometer, or one or more other sensor. The machine 700 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 726 (e.g., software, programs, an operating system (OS), etc.) or other data are stored on the storage system 718 can be accessed by the main memory 704 for use by the processing device 702. The main memory 704 (e.g., DRAM) is typically fast, but volatile, and thus a different type of storage than the storage system 718 (e.g., an SSD), which is suitable for long-term storage, including while in an “off” condition. The instructions 726 or data in use by a user or the machine 700 are typically loaded in the main memory 704 for use by the processing device 702. When the main memory 704 is full, virtual space from the storage system 718 can be allocated to supplement the main memory 704; however, because the storage system 718 device is typically slower than the main memory 704, and write speeds are typically at least twice as slow as read speeds, use of virtual memory can greatly reduce user experience due to storage system latency (in contrast to the main memory 704, e.g., DRAM). Further, use of the storage system 718 for virtual memory can greatly reduce the usable lifespan of the storage system 718.

The instructions 724 may further be transmitted or received over a network 720 using a transmission medium via the network interface device 708 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi-Æ, IEEE 802.16 family of standards known as WiMax-Æ), IEEE 802.15.4 family of standards, peer-to-peer (P2P) networks, among others. In an example, the network interface device 708 may include one or more physical jacks (e.g., Ethernet, coaxial, or phone jacks) or one or more antennas to connect to the network 720. In an example, the network interface device 708 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as examples. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

As used herein, directional adjectives, such as horizontal, vertical, normal, parallel, perpendicular, etc., can refer to relative orientations, and are not intended to require strict adherence to specific geometric properties, unless otherwise noted. It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

As used in any embodiment herein, the term “logic” may refer to firmware or circuitry configured to perform any of the aforementioned operations. Firmware may be embodied as code, instructions or instruction sets, as data hard-coded (e.g., nonvolatile) in memory devices or circuitry, or combinations thereof.

“Circuitry,” as used in any embodiment herein, may comprise, for example, any combination or permutation of hardwired circuitry, programmable circuitry, state machine circuitry, logic, or firmware that stores instructions executed by programmable circuitry. The circuitry may be embodied as an integrated circuit, such as an integrated circuit chip. In some embodiments, the circuitry may be formed, at least in part, by the processor circuitry executing code or instruction sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

What is claimed, is:

1. A system for providing multispectral vision, the system comprising:
a transmitting device configured to capture multispectral information across a plurality of spectral bands including visible light and at least one non-visible spectral band, and distribute the multispectral information over a specific area;
a receiving device comprising:
a sensor configured to receive the distributed multispectral information;
a processor configured to process the received multispectral information in accordance with at least one user-provided configuration setting by translating information in a non-visible spectral band into information in a visible spectral band; and
a display configured to present the translated visible spectral band information in combination with received visible light information by overlaying the translated information on the visible light information.

2. The system of claim 1, wherein the at least one non-visible spectral band comprises infrared, ultraviolet, X-ray, or microwave radiation and the transmitting device is configured to modulate and encode the captured multispectral information prior to distribution.

3. The system of claim 1, wherein the receiving device, processor, and display are integrated into an augmented reality headset worn by a user.

4. The system of claim 1, wherein the user-provided configuration settings comprise controls for adjusting color, brightness, saturation, contrast, or flickering rate of the translated visible spectral band information presented on the display.

5. The system of claim 1, further comprising:
receiving via a user interface of the receiving device a user-provided configuration setting specifying mapping of infrared wavelengths to hues in a red/green visible spectrum; and
processing infrared data from the received multispectral information by shifting different infrared wavelengths into corresponding hues in the red/green visible spectrum according to the user-provided configuration setting;
wherein the display is configured to present the infrared data translated into the red/green hues overlaid on imagery derived from the received visible light information.

6. The system of claim 1, further comprising:
receiving via a user interface of the receiving device a user-provided configuration setting specifying mapping of ultraviolet wavelengths to hues in a blue/purple visible spectrum; and
processing ultraviolet data from the received multispectral information by shifting different ultraviolet wavelengths into corresponding hues in a blue/purple visible spectrum according to the user-provided configuration setting;
wherein the display is configured to present the ultraviolet data translated into the blue/purple hues overlaid on imagery derived from the received visible light information.

7. The system of claim 1, further comprising:
receiving via a user interface of the receiving device a user-provided configuration setting specifying mapping of multiple non-visible spectral bands to different colors in a visible spectrum; and
processing data from the multiple non-visible spectral bands by shifting each non-visible band into a corresponding color in the visible spectrum according to the user-provided configuration setting;
wherein the display is configured to present the multiple non-visible bands as a single composite overlay with the different colors representing the different non-visible bands overlaid on imagery derived from the received visible light information.

8. A method for providing multispectral vision, the method comprising:
capturing, by a transmitting device, multispectral information across a plurality of spectral bands including visible light and at least one non-visible spectral band;
distributing, by the transmitting device, the captured multispectral information over a specific area;
receiving, by a sensor of a receiving device, the distributed multispectral information;
processing, by a processor of the receiving device, the received multispectral information in accordance with at least one user-provided configuration setting by translating information in a non-visible spectral band into information in a visible spectral band; and
presenting, on a display of the receiving device, the translated visible spectral band information in combination with received visible light information by overlaying the translated information on the visible light information.

9. The method of claim 8, wherein the at least one non-visible spectral band comprises infrared, ultraviolet, X-ray, or microwave radiation and the method further comprises modulating and encoding, by the transmitting device, the captured multispectral information prior to distribution.

10. The method of claim 8, wherein the receiving device, processor, and display are integrated into an augmented reality headset worn by a user.

11. The method of claim 8, wherein the user-provided configuration settings comprise controls for adjusting color, brightness, saturation, contrast, or flickering rate of the translated visible spectral band information presented on the display.

12. The method of claim 8, further comprising:
receiving via a user interface of the receiving device a user-provided configuration setting specifying mapping of infrared wavelengths to hues in a red/green visible spectrum;
processing infrared data from the received multispectral information by shifting different infrared wavelengths into corresponding hues in the red/green visible spectrum according to the user-provided configuration setting;
wherein presenting includes presenting the infrared data translated into the red/green hues overlaid on imagery derived from the received visible light information.

13. The method of claim 8, further comprising:
receiving via a user interface of the receiving device a user-provided configuration setting specifying mapping of ultraviolet wavelengths to hues in a blue/purple visible spectrum;
processing ultraviolet data from the received multispectral information by shifting different ultraviolet wavelengths into corresponding hues in a blue/purple visible spectrum according to the user-provided configuration setting;
wherein presenting includes presenting the ultraviolet data translated into the blue/purple hues overlaid on imagery derived from the received visible light information.

14. The method of claim 8, further comprising:
receiving via a user interface of the receiving device a user-provided configuration setting specifying mapping of multiple non-visible spectral bands to different colors in a visible spectrum;
processing data from the multiple non-visible spectral bands by shifting each non-visible band into a corresponding color in the visible spectrum according to the user-provided configuration setting;
wherein presenting includes presenting the multiple non-visible bands as a single composite overlay with the different colors representing the different non-visible bands overlaid on imagery derived from the received visible light information.

15. A system for providing multispectral vision, the system comprising:
a receiving device comprising:
a sensor configured to receive multispectral information across a plurality of spectral bands including visible light and at least one non-visible spectral band;
a processor configured to translate the received multispectral information into neuronal maps corresponding to the received multispectral information;
a transmitter configured to transmit the neuronal maps; and
a neuronal linked device configured to:
receive the transmitted neuronal maps;
transcribe the received neuronal maps into electrical impulses; and
deliver the electrical impulses to a user's brain to allow the user to perceive the received multispectral information.

16. The system of claim 15, wherein the at least one non-visible spectral band comprises infrared, ultraviolet, X-ray, or microwave radiation.

17. The system of claim 15, wherein the transmitting device comprises a camera equipped with multispectral sensors.

18. The system of claim 15, wherein the transmitter and neuronal linked device communicate wirelessly via Bluetooth or Wi-Fi.

19. The system of claim 15, wherein the neuronal linked device comprises an implanted brain computer interface including one or more electrodes surgically implanted within the user's brain to facilitate direct transmission of the electrical impulses to the visual cortex region.

20. A method for providing multispectral vision, the method comprising:
receiving, by a sensor of a receiving device, multispectral information across a plurality of spectral bands including visible light and at least one non-visible spectral band;
translating, by a processor of the receiving device, the received multispectral information into neuronal maps corresponding to the received multispectral information;
transmitting, by a transmitter of the receiving device, the neuronal maps;
receiving, by a neuronal linked device, the transmitted neuronal maps;
transcribing, by the neuronal linked device, the received neuronal maps into electrical impulses; and
delivering the electrical impulses to a user's brain to allow the user to perceive the received multispectral information.

21. The method of claim 20, wherein the at least one non-visible spectral band comprises infrared, ultraviolet, X-ray, or microwave radiation.

22. The method of claim 20, wherein the transmitting device comprises a camera equipped with multispectral sensors.

23. The method of claim 20, wherein the transmitting and receiving of the neuronal maps is performed wirelessly via Bluetooth or Wi-Fi.

24. The method of claim 20, wherein the neuronal linked device comprises an implanted brain computer interface including one or more electrodes surgically implanted within the user's brain to facilitate direct transmission of the electrical impulses to the visual cortex region.
